(19) United States
(12) Patent Application Publication
(10) Pub. No.: US 2003/0041398 A1
(43) Pub. Date: Mar. 6, 2003

(54) Motorized cleaning or polishing device

(76) Inventor: Lance Killingbeck, Cambridge (CA)

Correspondence Address: Mark B. Eisen, Dimock Stratton Clarizio, 20 Queen Street West, Suite 3202, Box 102, Toronto, Ontario, M5H 3R3, CA

(21) Appl. No.: 10/124,710

(22) Filed: Apr. 18, 2002

(30) Foreign Application Priority Data
Aug. 30, 2001 (CA) 2,356,771

(51) Int. Cl. B60S 3/06

(52) U.S. Cl. 15/53.1; 15/49.1; 15/50.1; 15/88.4

(57) ABSTRACT

A cleaning and polishing device comprises a cleaning and polishing means, a frame for maintaining the cleaning and polishing means disposed against the surface of the trailer, and a motor for moving the cleaning and polishing means along the surface of the trailer during cleaning.

### FIELD OF THE INVENTION

The invention relates to cleaning or polishing devices and more particularly to a motorized device for cleaning or polishing the surface of a trailer.

### BACKGROUND OF THE INVENTION

Like all automobiles, it is important to clean and polish tractor trailers periodically in order to keep them clean.

Typically, cleaning and polishing the surface of a trailer requires one or more persons to climb onto the trailer and clean and polish the trailer by hand. This process is very time consuming and strenuous.

There therefore is a need for a cleaning and polishing device for trailers that reduces the amount of manual labour required.

### SUMMARY OF THE INVENTION

The motorized cleaning and polishing device of the present invention, provides an improved means for cleaning and polishing the surface of trailers.

According to one aspect of the invention, there is provided a motorized cleaning or polishing device for cleaning or polishing a surface of a trailer, said device comprising a cleaning or polishing means, a frame for maintaining the cleaning or polishing means disposed against the surface of the trailer, and, a motor for moving the cleaning or polishing means along the surface of the trailer during cleaning or polishing.

In one embodiment of the invention, the cleaning or polishing means is a rotationally powered brush.

The motorized cleaning or polishing device of the present invention has many advantages. As the primary advantage, the motorized cleaning or polishing device provides a simple, time-saving device for cleaning or polishing the surface of trailers that reduces the time involved in manually cleaning or polishing the trailer by hand.

Numerous other objects, features and advantages will become apparent to the person skilled in the art upon reading the detailed description of the preferred embodiments, the drawings and the claims.

### BRIEF DESCRIPTION OF THE DRAWINGS

In drawings which illustrate by way of example only a preferred embodiment of the invention,

FIG. 1 is a top view of the first frame part and motor;

FIG. 2 is a side view of the interlocking first and second frame parts;

FIG. 3 is a front view of the second frame part and cleaning and polishing means;

FIG. 4 is a top perspective view of the cleaning and polishing means;

FIG. 5 is top view of the wheel, bar and guide wheels;

FIG. 6 is a perspective view of the motor and the worm gear box.

FIG. 7 is a front view of the motor, worm gear box and support;

FIG. 8 is a front view of the control assembly for the motor;

FIG. 9 is a side perspective view of the winch and the on/off switch for the second motor.

### DETAILED DESCRIPTION OF THE PREFERRED EMBODIMENTS

Referring to the Figures, the cleaning and polishing device of the present invention includes a frame, a cleaning and polishing means 5, and a motor 10.

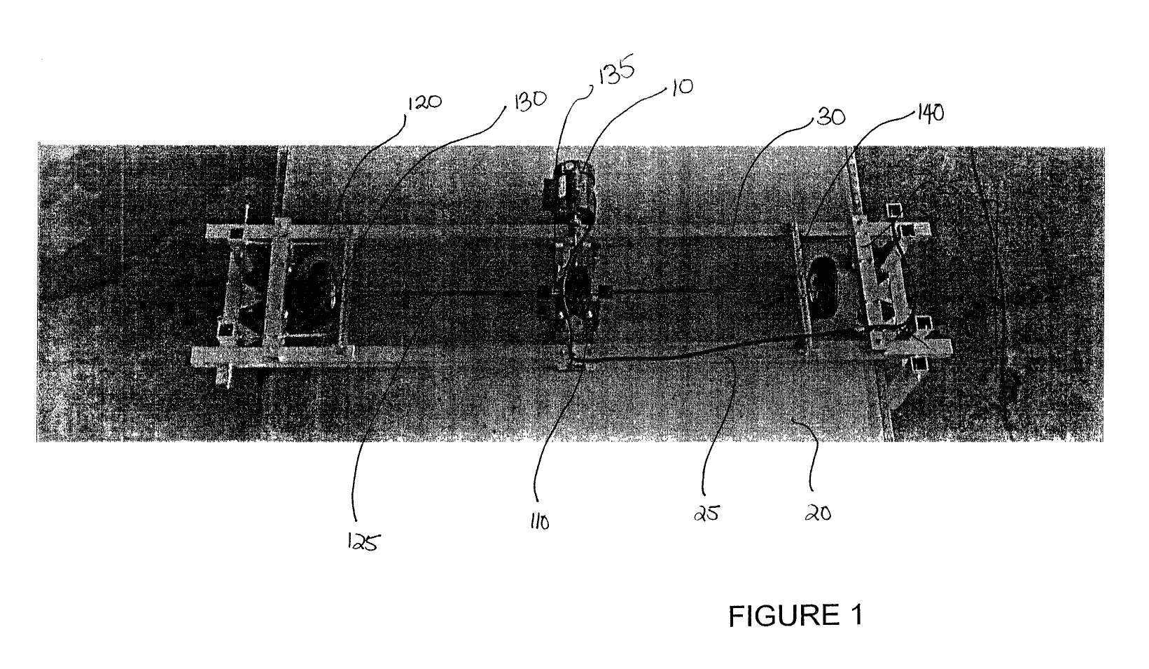

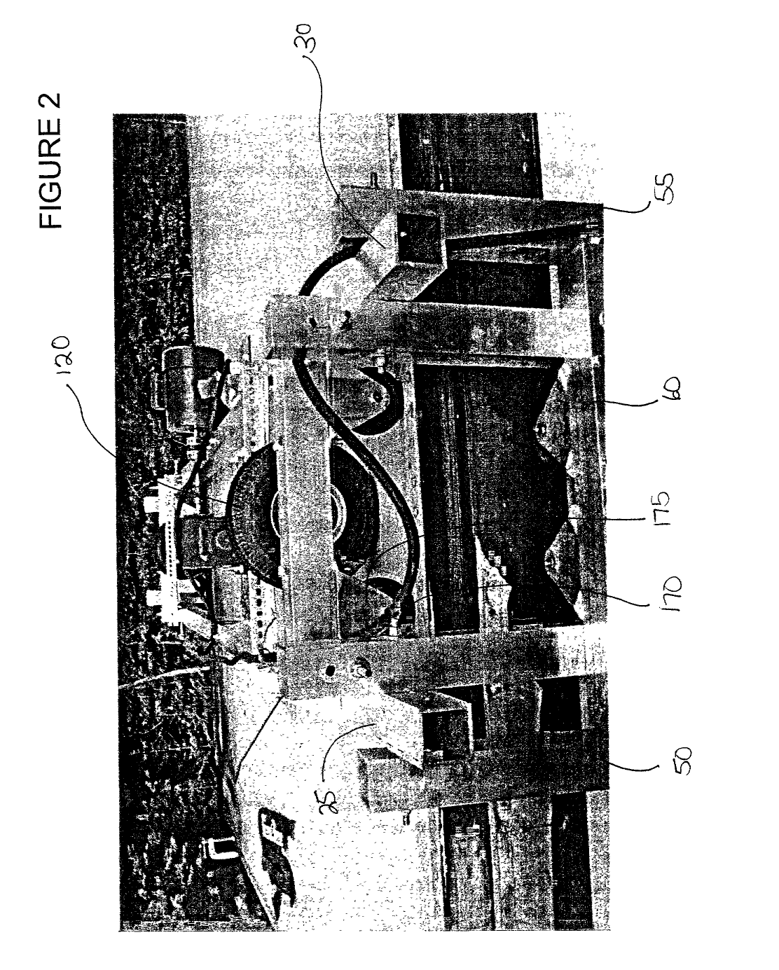

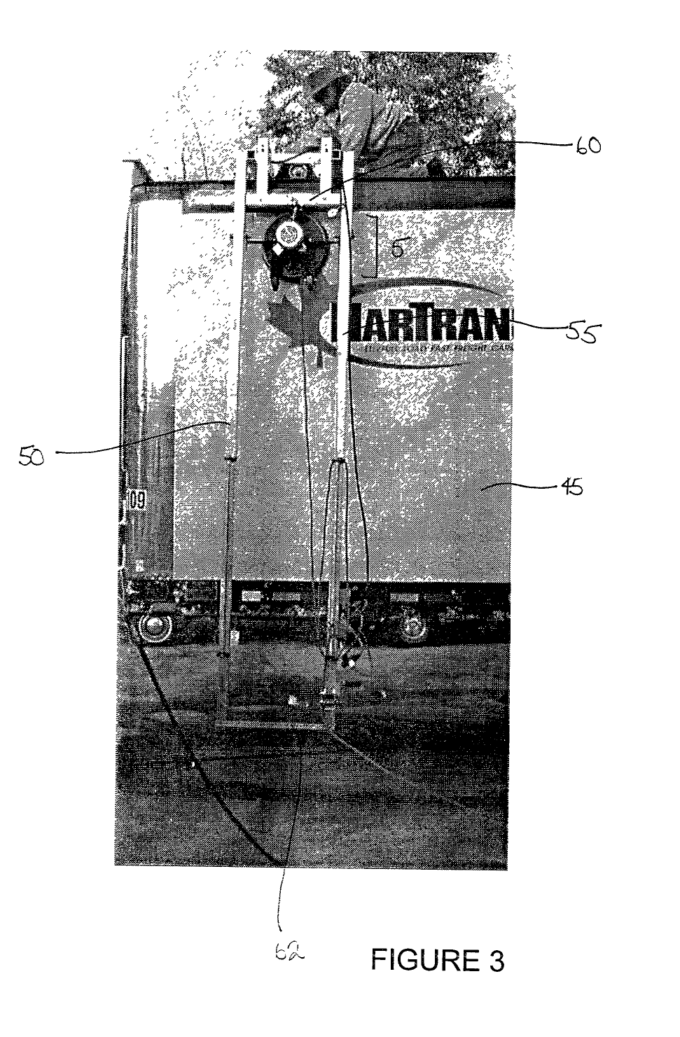

In a preferred embodiment as shown in FIGS. 1 and 2, the frame is comprised of two interlocking parts. A first frame part 15 extends along a top 20 of a trailer and comprises a pair of longitudinal rails 25, 30 and a pair of connecting end rails 35. As shown in FIG. 3, a second frame part 40 extends downwardly along a side 45 of the trailer and comprises a pair of vertical side rails 50 and 55 and a pair of connecting horizontal end rails 60, 62. Connecting horizontal end rail 62 serves as a ground engaging base support for the second frame part 45. Together, the first frame part 15 and the second frame part 45 move along the trailer, powered by the motor 10.

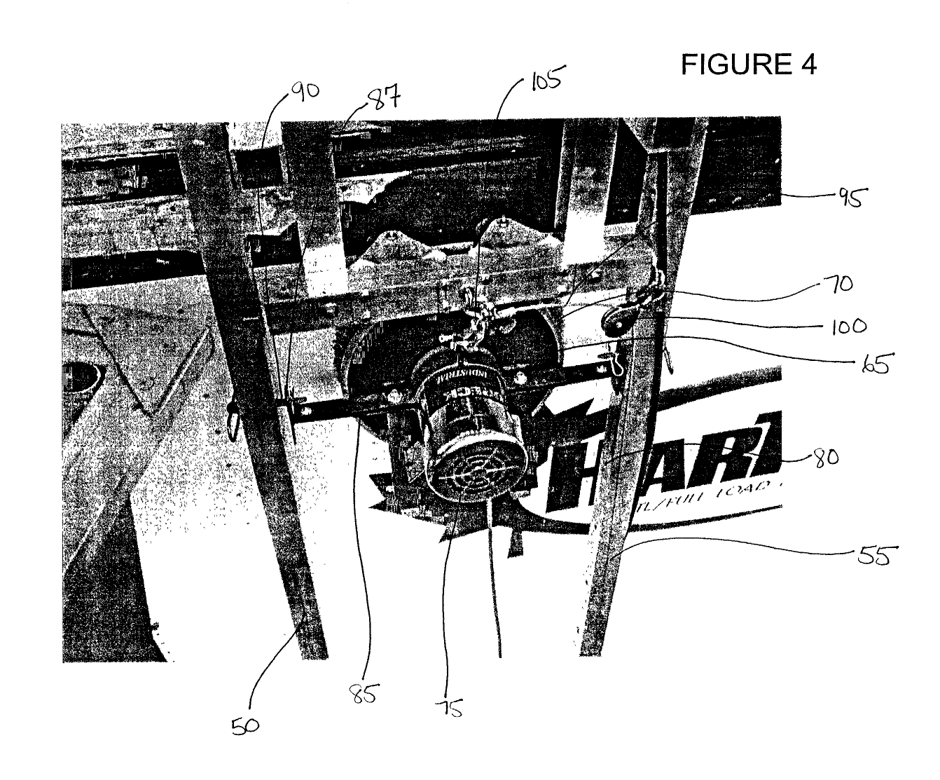

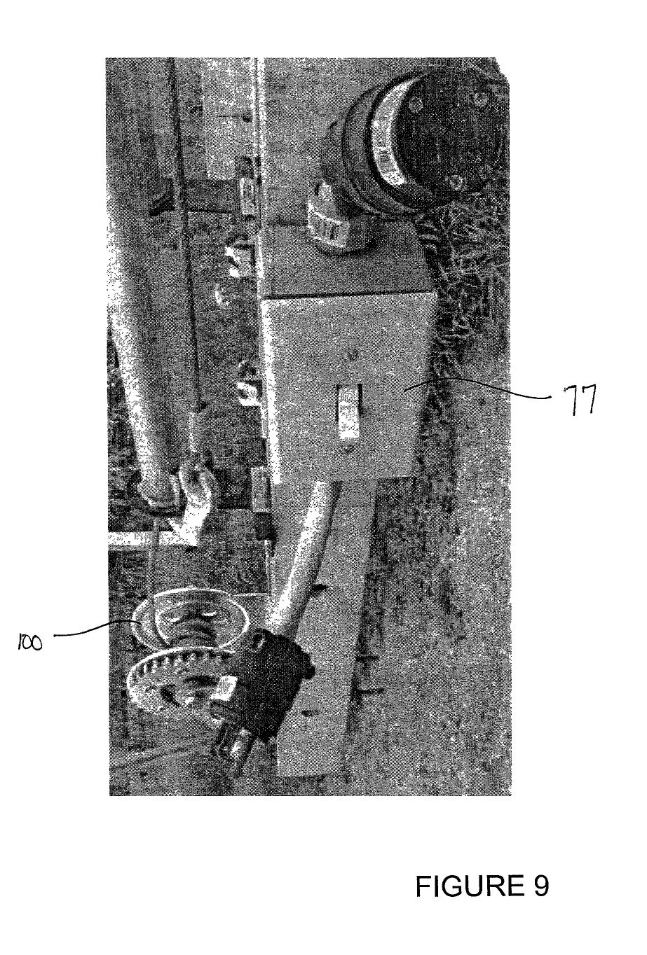

The cleaning and polishing means 5 can take on any number of forms. In a preferred embodiment, as shown in FIGS. 3 and 4, the cleaning and polishing means comprises a rotationally powered brush 65 that has a removable surface-cleaning end 70. The removable surface-cleaning end can include a scrub brush, wax pad, buffer brush or any other suitable cleaning device. The rotationally powered brush 65 is driven by a second motor 75, controlled by an on/off switch 71 (FIG. 9) located on the vertical side rail 55.

The cleaning and polishing means 5 is disposed between the vertical side rails 50, 55 and is held in place between the vertical side rails 50, 55 by both pin attachment and winch cable. Specifically, the vertical side rails 50, 55 include evenly spaced notches 80 that span the length of the vertical side rails 50, 55. A back support brace 85 is attached to a back side of the cleaning and polishing means 5 and around the second motor 75. Back support brace 85 extends outward toward vertical side rails 50, 55 and include side notches 87 which facilitate connection to vertical side rails 50, 55 by pins 90 inserted through notches 80 and side notches 87.This pin attachment provides additional support and safety to the cleaning and polishing means 5 when in use.

The cleaning and polishing means 5 is also held in place by a winch cable 95. Winch cable 95 attaches through a series of pulleys 100 (see FIG. 9) and a top loop 105 of the cleaning and polishing means 5 and is adjusted by a hand crank (not shown). The cleaning and polishing means 5 can be raised or lowered accordingly by turning the hand crank. The winch may also be an electric or hydraulic winch without deviating from the invention as claimed.

The motor 10 drives the frame and the cleaning and polishing means 5 across the trailer. As shown in FIG. 1, the motor 10 is preferably positioned adjacent a centre of longitudinal rail 30.

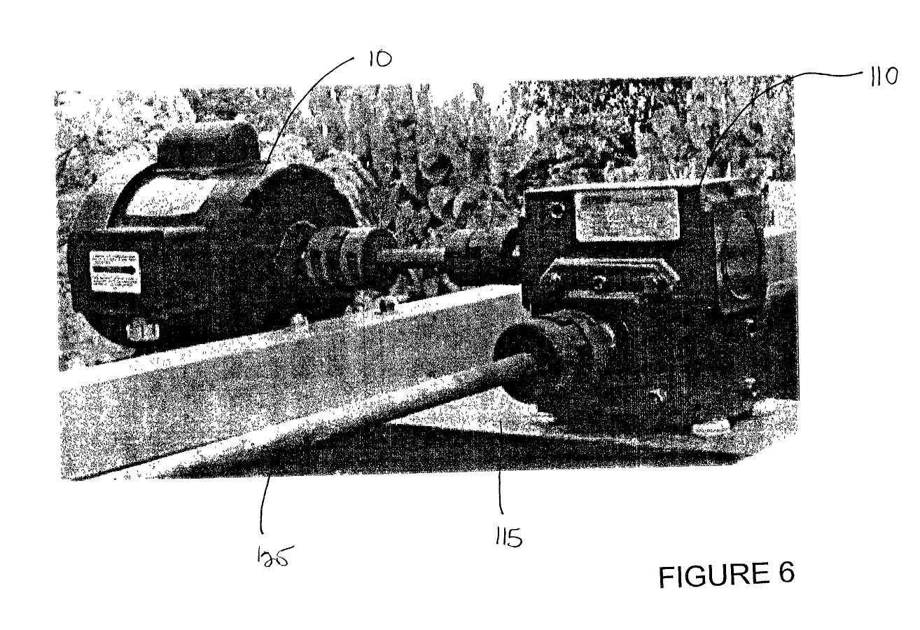

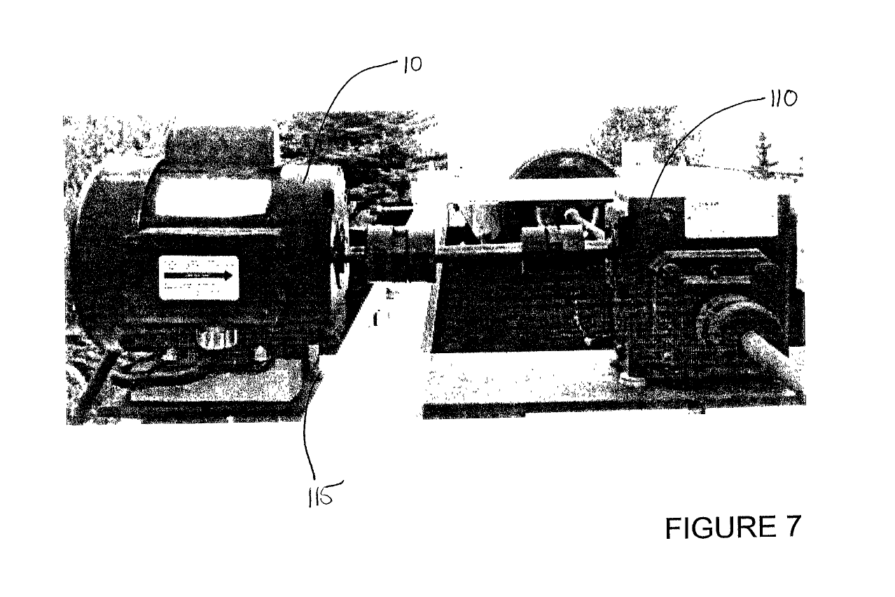

As shown best in FIGS. 6 and 7, the motor 10 is connected to a worm gear box 110 located in the centre of the first frame part 15 between the longitudinal rails 25 and 30 Motor 10 rests on a support 115 that extends across the first frame part 15 and supports both the motor 10 and worm gear box 110. Worm gear box 110 is attached to support 115 and support 115 is attached to an underside of each of the longitudinal rails 25, 30 by nut and bolt attachment.

A set of drive wheels 120 (FIG. 1), is also disposed between the longitudinal rails 25, 30, adjacent to the end rails 35. Drive wheels 120 are rotationally connected by bars 125. Bars 125 are therefore attached at a first end 130, to the axles of drive wheels 120 and at a second end 135 to worm gear box 110 such that energy from the motor 10 is converted to the rotational movement of drive wheels 120. Drive wheels 120 are held in place by wheel braces 140 which lie inward of drive wheels 120 and parallel to end rails 35.

Movement of drive wheels 120 drives the movement of the frame and attached cleaning and polishing means 5. Worm gear box 110 serves to both translate the power of the motor 10 and to reduce the speed of the motor 10. It will be apparent to the person skilled in the art that the motor 10 and worm gear box 110 can be in either two pieces as provided by the preferred embodiment, or a single piece, without deviating from the invention as claimed.

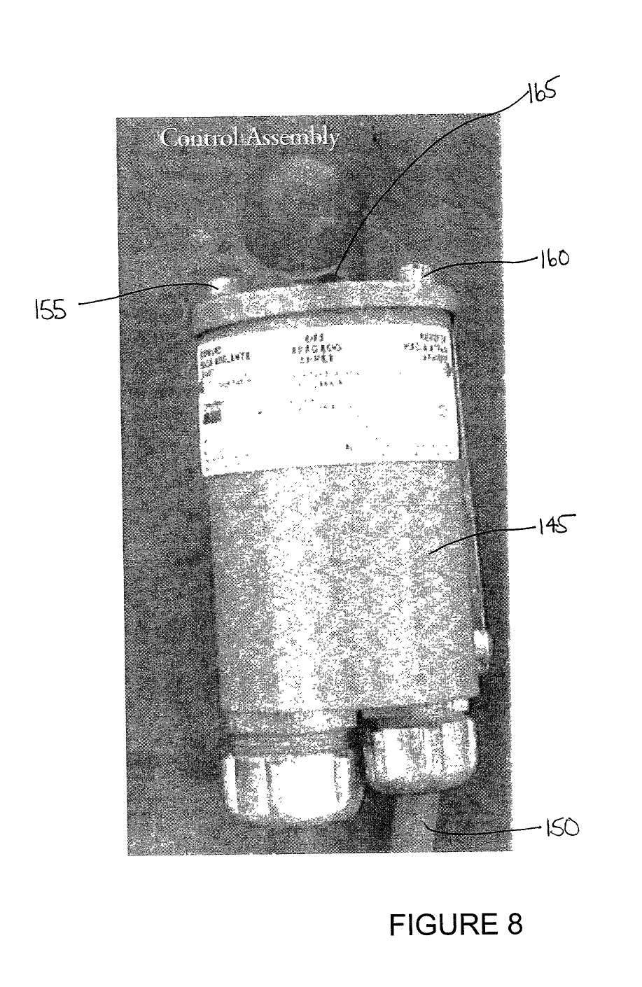

Motor 10 is activated by a control assembly 145 (FIG. 8), located on vertical side rail 55. Control assembly 145 is connected to the motor 10 by a connecting cable 150. The motor 10 can be activated so that it drives the frame in a forward and reverse direction. Accordingly, the control assembly 145 includes forward 155, reverse 160 and off 165 controls.

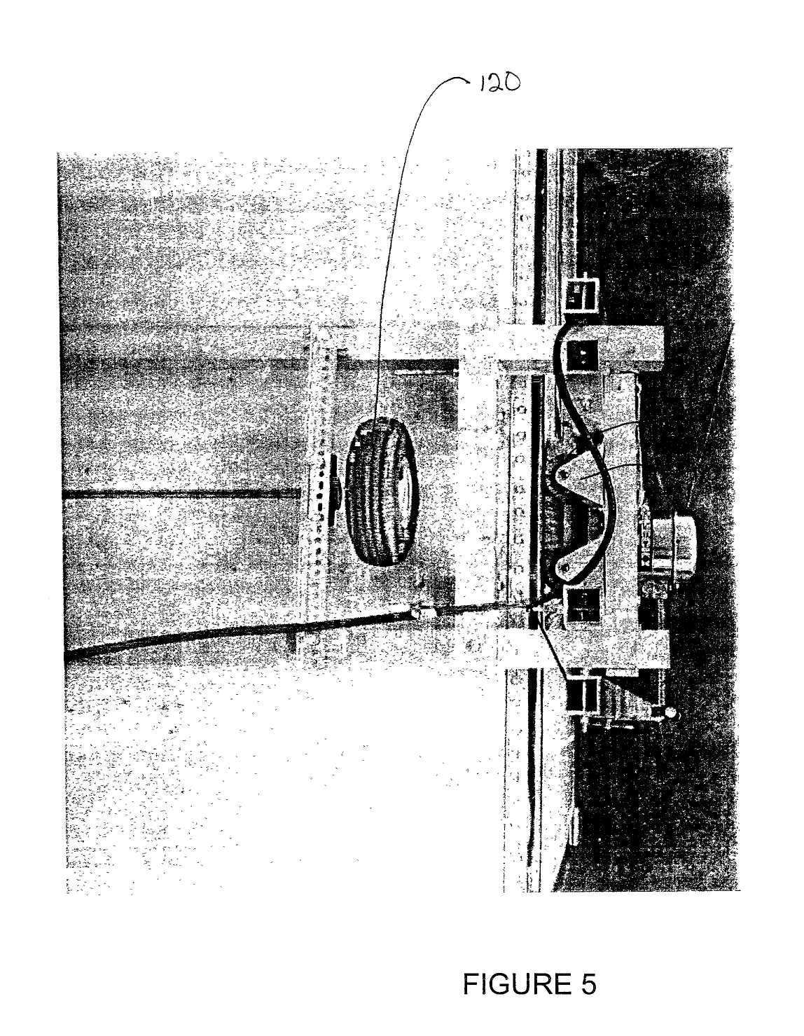

The first frame part 15 and second frame part 40 are prevented from slipping by guide wheels 170 (see FIGS. 2 and 5). Guide wheels 170 of the first frame part 15 are connected to a housing 175 on the underside of end rails 35. These guide wheels 170 run along the inside perimeter of the top 20 of the trailer. Guide wheels 90 of the second frame part 40 extend from a housing 180 on the underside of the horizontal connecting end rail 60. These guide wheels 90 run along a top edge of the side 45 of the trailer. Upon movement of drive wheels 120, guide wheels 90 move the frame smoothly along the trailer.

The cleaning and polishing device may also include emergency shutdown switches (not shown) on opposite ends of the trailer to prevent derailing of the frame from the trailer.

The cleaning and polishing device is portable and can be easily disassembled and assembled into its component parts.

In use therefore, the cleaning and polishing device is assembled by first setting the first frame part 15 across the top 20 of the trailer so that guide wheels 170 are appropriately set along the perimeter of the top 20 of the trailer. The motor 10, worm gear box 110 and support 115 are then bolted in place. The first frame part 40 is squared to the side 45.

The second frame part 40 is then interconnected with the first frame part 15 by individually attaching each vertical side rail 50, 55 to the longitudinal rails 25, 30 of the first frame part 15. A free end of the connecting cable 150 is then lowered from the top 20 of the trailer and plugged into the control assembly 145 on the vertical side rail 55.

The cleaning and polishing means 5 is disposed between the vertical side rails 50, 55 by first looping the winch cable 95 around pulleys 100 and then through the top loop 165. The cleaning and polishing means 5 is attached to the winch cable 95 and the hand crank is operated to move the cleaning and polishing means 5 to the desired height. The cleaning and polishing means 5 is given added support by pinning the back support brace 55 to the vertical side rails 50, 55 using pins 90, notches 80 and side notches 87.

In order to operate the cleaning and polishing device, the side 45 of the trailer is manually sprayed with cleaner, such as water and citric acid. Once the cleaner has been applied, the control assembly 145 and on/off control 77 is turned on and the frame is allowed to move along the trailer while the rotationally powered brush 65 scrubs the side of the trailer 45. Applying hand pressure to vertical side rails 50, 55 helps to maintain the rotationally powered brush 65 snugly against the side of the trailer 45. It will be apparent that the second frame part 40 may also be adapted to include a sprayer unit for distributing washes, waxes and water to the side 45 of the trailer as the cleaning and polishing device is in operation.

The power of the motor 10 may be varied to accommodate the speed of cleaning. Preferably, the motor 10 is a one half horse power electrical motor turning 1725 rpm, attached to a speed reducer of 50: 1. The motor 10 moves the frame at a rate of three miles/hour. However, a variable speed sensor can be used to allow the frame to move from 0 to 3 miles/hour.

When the frame reaches an opposite end of the trailer, the control assembly 145 can be moved to reverse 160 to move the frame back across the trailer. When a horizontal patch of the trailer has been cleaned to desired quality, the motor 10 and rotationally powered brush 65 are turned off, and the cleaning and polishing means 5 is lowered by removing the pins 90, and lowering the cleaning and polishing means 5 using the hand crank. The cleaning and polishing means 5 is re-pinned by placing the pins 90 into the next lowest notch 80 on the vertical side rails 50, 55. The motor 10 and rotationally powered brush 65 are turned on again and the frame is allowed to move across the next horizontal path while the rotationally powered brush 65 scrubs the side 45 of the trailer.

Once cleaning is complete, the surface cleaning end 70 of the rotationally powered brush 65 can be removed and replaced with a waxing and polishing pad and the process is repeated again.

When one side 45 of the trailer has been fully cleaned and polished, the second frame part 40 and cleaning and polishing means 5 can be disassembled and moved to a second side of the trailer to repeat the process again. It will be apparent to the person skilled in the art that the cleaning and polishing device can be accommodated with a second frame part 40 on each side of the trailer to clean and polish both sides of the trailer simultaneously.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A motorized cleaning or polishing device for cleaning or polishing a surface of a trailer, said device comprising:
a cleaning or polishing means;
a frame for maintaining the cleaning or polishing means disposed against the surface of the trailer and,
a motor for moving the cleaning or polishing means along the surface of the trailer during cleaning or polishing.

2. The cleaning or polishing device of claim 1, wherein the cleaning or polishing means comprises a rotationally powered brush.

3. The cleaning or polishing device of claim 2, wherein the rotationally powered brush can have a scrub, wax or buff end.
